(19) United States
(12) Patent Application Publication
(10) Pub. No.: US 2008/0082301 A1
(43) Pub. Date: Apr. 3, 2008

(54) Method for designing and fabricating a robot

(76) Inventors: Sabrina Haskell, Pittsburgh, PA (US); Andrew Hosmer, Pittsburgh, PA (US); Peter Stepniewicz, Orlando, FL (US); Salim Zayat, San Francisco, CA (US)

Correspondence Address: MEYER UNKOVIC & SCOTT LLP, 1300 OLIVER BUILDING, PITTSBURGH, PA, 15222, US

(21) Appl. No.: 11/906,570

(22) Filed: Oct. 3, 2007

Related U.S. Application Data
(60) Provisional application No. 60/848,966, filed on Oct. 3, 2006.

(51) Int. Cl. G06F 17/50; G06F 19/00

(52) U.S. Cl. 703/1; 700/98

(57) ABSTRACT

A method for designing and fabricating a robot utilizes 3D modeling tools and techniques. The method begins with creating a digital three-dimensional model of the robot. A 3D mechanical structure for the robot is designed based on the digital model. Aesthetic (typically external) and mechanical (typically internal) components based on the digital model and mechanical design are fabricated utilizing rapid prototyping machines and techniques. Other components are obtained or fabricated according to the 3D model and mechanical structure as needed. The aesthetic and mechanical components are then assembled into a completed robot.

### CROSS-REFERENCE TO RELATED APPLICATION

This application claims the benefit of U.S. Provisional Patent Application No. 60/848,966, filed on Oct. 3, 2006.

### FIELD OF THE INVENTION

The present invention relates to a method for designing and fabricating a robot. More particularly, this invention relates to a method of using 3D modeling tools and techniques to design and build a robot in virtual space and then fabricating and building that robot based on the generated 3D model.

### BACKGROUND OF THE INVENTION

In the past, robots and more particularly robotic animatronic devices have been designed and fabricated in two largely separate phases. Typically, the mechanical components of an animatronic device are designed first, often with functional requirements and goals as the top design priority. Such mechanical components are situated, most often, inside an outer robot shell or exterior for cosmetic and/or aesthetic reasons. In some instances, however, designers may prefer certain robotic internal mechanical components to be seen, either by placing a clear (see through) shell over these components, or having no external shell at all.

Only after the mechanical (typically “internal”) components have been designed and/or fabricated, are the aesthetic, cosmetic (typically “external”) components finalized. Builders then fit these aesthetic components onto the fabricated mechanical components to make an operational robotic device that conforms to the desired appearance. As mentioned above, it is often the case that the internal structure of the robot is comprised primarily of the mechanical components while the external, visible structure of the robot consists generally of the aesthetic components. Thus this design approach can be thought of as an “inside out” approach to robot building, that is the aesthetic components are designed to fit around the mechanical components of the robot. When compromises are required, it is often the aesthetic components that must be altered, especially if fabrication of the mechanicals has already started. As a result, robots created by this method do not often match their original aesthetic conception.

Problems also occur when: (a) necessary mechanical components do not fit comfortably among already fabricated aesthetic components; or (b) the aesthetic components interfere with the physical operation of mechanical components of the robot. When such problems arise, it is necessary to go back and re-fabricate some or all of the aesthetic components so that they are able to fit with the necessary mechanical components yet still allow for proper functioning in the robotic device. Building is then re-attempted. If newly fabricated components still do not lead to an operational device, the method must be started over again.

Robot fabrication by the above method can be highly time consuming and expensive in terms of labor, raw materials and parts used. The end product often includes many compromises in the matter of aesthetics, use and operation. Moreover, such fabrication methods are inflexible, granting little leeway in the aesthetic design of robotic devices and curbing creativity in the design of such devices.

What is needed, therefore, is a method with increased flexibility in the design and fabrication of robotic devices. This method should enable final robotic products to more closely match their original aesthetic conception and allow for the troubleshooting of design and fabrication problems before actual components of the device have been fabricated. The invention described below includes a method for designing and fabricating a robot through the use of digital design tools. This method allows robotic engineers to design the aesthetic and mechanical components of an animatronic device simultaneously, in a virtual environment, to ensure that all functional requirements are met before any physical fabrication of device components (aesthetic or mechanical) has begun. It also allows for physical components to be more directly based on their digitally designed representations.

### SUMMARY OF THE INVENTION

An object of the present invention is to provide a method for designing and fabricating a robot that provides greater flexibility in the aesthetic and functional design of such devices.

Another object of the present invention is to provide a method for designing and fabricating a robot that allows for troubleshooting of potential design problems before fabrication of the device has begun in order to lower both material and labor costs in such robot fabrication.

Another object of the present invention is to provide a method for designing and fabricating a robot that utilizes modern tools and techniques for modeling a robot's design and aesthetic (mostly external) and mechanical (mostly internal) components within a virtual space. By this method, the aesthetic and mechanical components can be fit together, operability of the design confirmed, and potential problems with the design discovered and addressed by testing (or pre-testing) on the model before the fabrication and assembly of physical components has begun.

Specifically, what is disclosed is a method for designing and fabricating a robot. This method commences by creating an initial design of the robot, creating a digital three-dimensional (“3D”) model of the robot design; and creating a 3D mechanical design for the mechanical structure of that robot based on the digital 3D model. Next, the method proceeds by: fabricating relevant aesthetic components of the robot based on the digital 3D model; fabricating the relevant mechanical components of the robot based on the mechanical design; and assembling the mechanical and aesthetic components into a completed, physical robot.

The steps of fabricating aesthetic and mechanical components of the robot may be performed sequentially or simultaneously.

According to another embodiment of this invention, the steps of creating the digital 3D model and creating the mechanical design of the mechanical structure may be performed iteratively so as to ensure that the mechanical structure and components fit sufficiently among the aesthetic components and that the robot will operate properly.

In one embodiment, the method of fabricating certain internal or external components of the robot includes using a physical rapid-prototyping machine to create physical pieces or sectional components of the digital 3D model and 3D mechanical design. Alternatively, the method of fabricating components of the robot may include: (a) creating molds from the physical pieces/sectional components; (b) casting the rigid components from the molds; and (c) casting the flexible components from the molds.

In other instances, the step of fabricating components of the robot includes reinforcing the physical pieces with a liquid hardener before creating the molds therefrom. In addition, one may find it prudent to refine imperfections in these physical pieces before creating any molds from same.

According to one embodiment of this invention, rigid components of the robot may be cast from each of the aforementioned molds by: (i) pouring catalyzed liquid into one or more mold pieces; (ii) reassembling the pieces of the mold and fastening the mold together; (iii) rotating the fastened mold until the catalyzed liquid in the mold has sufficiently hardened; and (iv) opening the mold pieces to remove the rigid components of the robot therefrom. Optionally, the aforesaid component casting method may further include: building up layers of material and catalyzed liquid in one or more of such mold pieces prior to the catalyzed liquid pouring step (i) above.

According to one embodiment of this invention, flexible components for the robot may be cast from each of the aforementioned molds by: (i) pouring catalyzed liquid into one or more mold pieces; (ii) reassembling the mold pieces and fastening them together; (iii) rotating the fastened molds until the catalyzed liquid has sufficiently firmed up; and (iv) opening the molds to remove the flexible components cast in same.

The steps of casting rigid and flexible components from molds may be performed sequentially or simultaneously. Some robot designs may only contain rigid components, while others contain only flexible components. In some embodiments of this invention, therefore, one of these casting steps may be omitted.

According to another embodiment of this invention, certain components of the robot may be commercially obtained, when available, to reduce costs; and/or custom designed and fabricated by other processes.

### BRIEF DESCRIPTION OF THE DRAWINGS

FIG. 1 illustrates a flow diagram representing a method for the rapid design and fabrication of a robot according to a preferred embodiment of the present invention.

FIG. 2 illustrates a flow diagram representing one method for fabricating components of the robot.

FIG. 3 illustrates a flow diagram representing a method for casting rigid components of the robot.

FIG. 4 illustrates a flow diagram representing a casting method for flexible components of the robot.

FIG. 5 illustrates a flow diagram representing a method for fabricating components of the robot.

### DETAILED DESCRIPTION OF PREFERRED EMBODIMENTS

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

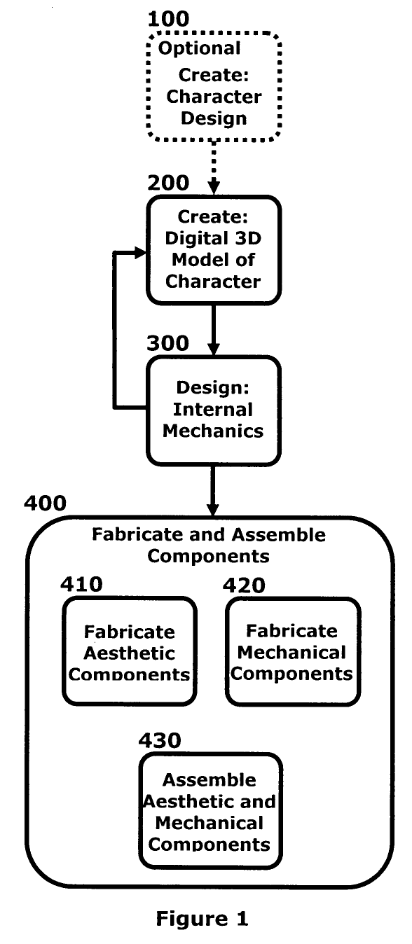

Referring to FIGS. 1-5, a method for the design and fabrication of a robotic device is disclosed according to certain preferred embodiments of the present invention.

The robot fabrication method begins with an initial robot character design phase (100) as illustrated in FIG. 1. Step 100 typically includes making two dimensional (“2D”) sketches and/or a small-scale physical model of how the robot will look. Step 100 is optional. It is to be understood that an artist may skip the 2D sketching and/or small scale model building stage (100) and instead start at step 200, creating a 3D digital model of the robot.

As referenced in FIG. 1, a digital 3D model of the character is created by step 200. It is understood by those skilled in the art that many different methods for creating a digital 3D model exist. The two most common methods are detailed below:
A 3D model can be created using a computer, keyboard, mouse, computer display, and digital modeling software such as the MAYA® program made and sold by Alias Systems Corp., the 3DS MAX® program made and sold by Autodesk, Inc., the LIGHTWAVE® program made and sold by Newtek, Inc., and/or the SOLIDWORKS® program made and sold by SolidWorks Corp. There are many techniques for creating a model using digital software applications like these. Such techniques include, but are not limited to: combining primitives, extruding, lofting, box modeling, facet modeling, constructive solid geometry, parametric based modeling and combinations thereof.
A physical sculpture is created, and then imported into a digital modeling software application. There are several ways of importing 3D digital representations of a physical sculpture into such modeling software applications, any of which may be used. They include, but are not limited to: performing a 3D scan of the physical sculpture, or creating a 3D photo model of the physical sculpture.

Once the digital 3D model is complete, the mechanical design process at step (300) takes place. Digital modeling software applications like those mentioned above, namely MAYA®, 3DS MAX®, LIGHTWAVE®, SOLIDWORKS®, may be used to create the design of a robot's armature (i.e. skeleton) directly inside the 3D model. The same software application may be used for both method steps. Alternately, a different software application from the first 3D modeling step may be used to create the armature design. In one embodiment, for example but not by limitation, the 3D model is created in MAYA® (an application primarily used for 3D modeling and animation), before being exported to SOLIDWORKS® (an application primarily used for engineering design) for performing the subsequent mechanical design steps.

By designing directly inside the 3D model, the mechanical designer can ensure that the armature is created to the exact specification of the 3D model. The designer can then use software applications to place joints, motors, pulleys, cables, screws, bolts, and other required hardware for the functionality of that robot directly inside the 3D model. If the software application selected also supports movement simulation, such mechanical designing can be truly iterative. As the armature design is developed and joints, motors and other parts are added, the movement of the design may be tested to keep such movement within specifications. If the modeled robot does not move properly, the mechanical design can be refined and retested. In that manner, the robotic mechanical design can be fully validated before a single physical piece has been fabricated.

Optionally, both steps 200 and 300 can be performed iteratively, as demonstrated in FIG. 1. While designing mechanics for the robot, the aesthetic 3D character model may need to be adjusted. For example, to achieve a desired functionality, the mechanical designer may have to house fifteen or more motors inside the robot's head. When using an engineering design application to place up to fifteen motors inside the head of a 3D model, the mechanical designer may soon discover that the original head design is undersized. The designer communicates the same to the 3D digital artist who increases head size in the digital robot model. The mechanical designer then attempts to fit fifteen motors in the modified 3D head. In this manner, the mechanical designer and 3D digital artist can work back-and-forth, iteratively, until the mechanicals all fit within the 3D model's specified dimensions.

After the aesthetic 3D character modeling and functional mechanics are finalized in virtual space, the physical fabrication of component parts (step 400 in FIG. 1) may begin. Fabrication and assembly of the aesthetic and mechanical components (steps 410, 420, and 430) can be performed in series or in parallel.

There are several methods for fabricating the aesthetic and mechanical components. Two representative methods are described below.

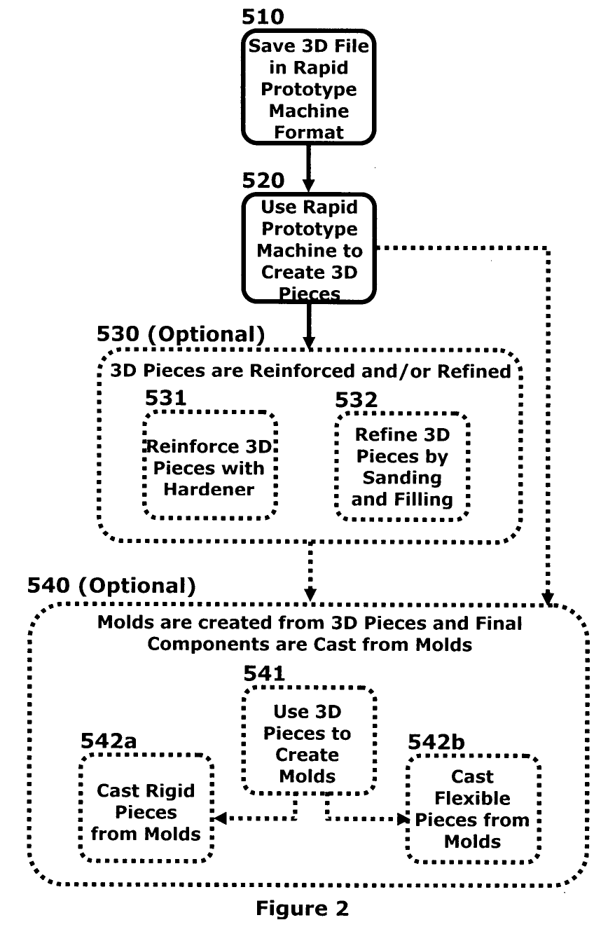

One method for fabricating components of the robot is illustrated at step 500 of FIG. 2. First, the digital 3D model (created in step 200) and/or components in the mechanical design (created in step 300) are saved in a file format readable by a 3D printer or other rapid-prototyping machine (step 510). For example, files in a stereolithography format (.stl) can be read by most 3D printers.

The machine-readable file (created in step 510) is loaded onto a 3D printer or other rapid-prototyping machine. The latter device then creates physical pieces of the digital 3D model and/or mechanical design components (step 520). Some 3D printers, for example, are additive fabrication machines in which layers of a material (e.g. plastic, resin, powder, or like material) are bonded together in successive layers to create a 3D object. There are many types of such 3D printers including: a plastic-based, Fused Deposition Modeler (FDM), a resin-based Stereolithography (SLA) Prototyper and a powder-based printer, any of which may be used herein.

For some powder-based 3D printers, layers of a fine powder (e.g. cornstarch, plaster or like material) are bonded together with a water-based adhesive. The adhesive is “printed” in an extremely thin cross-sectional shape. A powder is sprayed onto that adhesive and the printing process repeats until complete thus building up a physical component part, layer by layer.

Optionally, the physical pieces created by the rapid-prototyping machine(s) in step 520 are reinforced and/or refined (step 530). When reinforcing, a liquid hardener is brushed onto a physical piece after which after that piece is hardened, sealed and strengthened (step 531). When refining, imperfections in a physical piece (such as small bumps, depressions or the like) can be smoothed with sandpaper or other abrasive material and/or filled in with auto-body filler or other appropriate hardening substances. A physical piece can be iteratively sanded and filled until the desired look is achieved (step 532).

The physical pieces created with rapid-prototyping machine(s) in step 520, and refined and/or strengthened in optional step 530, can be used as final components of the robot. Or such pieces can be used to create molds from which to cast final components (step 540). Although any type of molds can be produced from such pieces, the following two types of mold manufacturing methods are preferred (step 541):
Liquid based—Each physical piece (or “plug”) is placed in a container. A catalyzed liquid, like plaster or silicone, is poured into that container for submerging the physical piece in said liquid. After the liquid sufficiently cures or hardens, a mold is removed from the container and cut in two or more sections around a center axis of the piece. The cut mold is pulled apart and the piece (plug) removed along with any piece residues in the mold.
Fiberglass based—The surface of each physical piece (or “plug”) is divided into two or more sections. A fiberglass cloth or mat is placed on the surface of a plug section. Catalyzed resin is applied over the fiberglass, contouring it to the surface of the plug. Another layer of fiberglass is placed over the resin before that layer is covered with more resin. These steps are repeated until the fiberglass reaches a desired level of thickness. After the resin has sufficiently hardened, the section of fiberglass mold is pulled from the plug surface and any plug residue removed. Each section of the mold may be made by the same method.

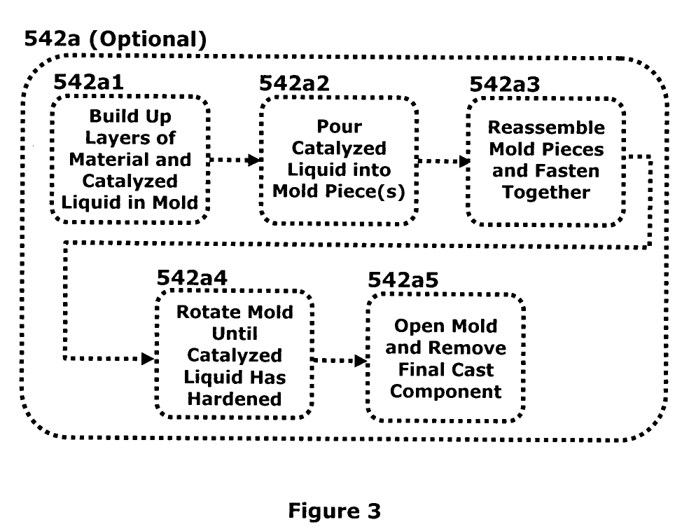

Final components for the robot can then be cast from the aforementioned molds (steps 542a and 542b). Many different types of casting processes are known. Any of them can be used with this invention. Most involve the same general principles. See, for example, the method for casting rigid components of the robot at step 542a of FIG. 3. Such castings may begin with the optional step of laying a reinforcing material like fiberglass cloth inside each mold piece. A catalyzed liquid is applied to that material for contouring it to the inner mold surface. More layers of reinforcing material and catalyzed liquid are then applied until the reinforcing material reaches the desired thickness (step 542a1).

A catalyzed liquid (such as plaster or resin) is next poured into one of these mold pieces (step 542a2). The mold pieces are reassembled and fastened together (step 542a3). The fastened mold is then slowly rotated around all three spatial axes as the catalyzed liquid therein sufficiently hardens (step 542a4). Axial rotation evenly distributes catalyzed liquid throughout the mold. After the liquid has hardened, the mold pieces are disassembled or otherwise pulled apart, releasing the final cast exterior component from the mold (step 542a5).

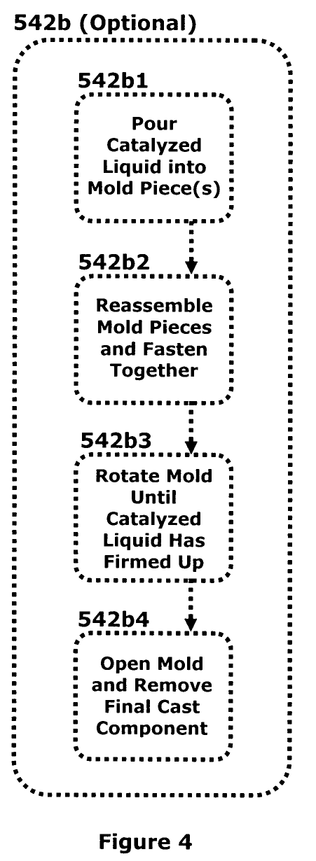

One representative method for casting flexible components of the robot (step 542b) is illustrated in FIG. 4. That casting begins by pouring a catalyzed liquid, like silicone, foam, or latex, into one of the mold pieces (step 542b1). The mold pieces are reassembled and fastened together (step 542b2). Like for rigid component manufacturing above, the flexible component mold is slowly rotated around all three spatial axes as the catalyzed liquid therein sufficiently firms up (step 542b3). That rotation evenly distributes catalyzed liquid throughout the mold. After the catalyzed liquid has sufficiently firmed, the mold pieces are disassembled and the cast flexible component released therefrom (step 542b4).

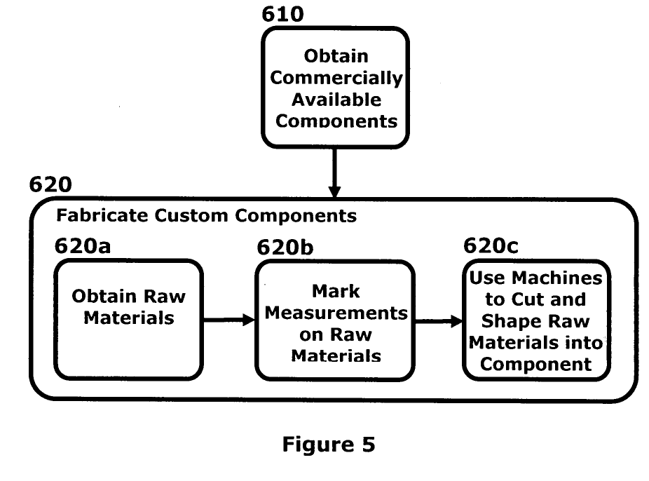

FIG. 5 illustrates another method for fabricating components of the robot (step 600). The 3D aesthetic model and/or 3D mechanical design schematics created with the above-listed software applications may be used as a reference to obtain and/or fabricate such components. First, any components that are available commercially may be obtained (step 610). Optionally, it may be desirable to cast alternatives to these commercially available components (see step 620) to reduce costs.

In any event, custom designed components will need to be fabricated (step 620). Typically, such custom components are fabricated in machine shops using power driven tools like lathes, milling machines, drill presses, grinders, forging machines, laser cutters, Computer Numerical Control (CNC) machines and the like. In order to make such components, with such machines, raw materials are first obtained (step 620a). These are typically metals, like aluminum and steel, and certain plastics. Next, mechanical schematics from the engineering design software are used to mark precise measurements of a component on a piece of raw material (step 620b). If a CNC machine is used, these measurements can be sent directly to the computer. Power driven machine tools then cut, shape and/or sculpt raw materials down to the proper sizes for the components of the robot (step 620c).

In a final fabrication (or assembly) step, aesthetic and mechanical components of the robot are joined together, to specification, per the mechanical design schematics created with the aforesaid engineering design software (step 430 in FIG. 1).

We claim:

1. A method for designing and fabricating a robot that allows for testing how components of the robot fit and work together before any such components are acquired or fabricated, said method comprising the steps of:
(a) creating a character design of said robot;
(b) creating a digital three-dimensional model of said character design;
(c) creating a mechanical design of a mechanical structure for said robot based on said digital three-dimensional model;
(d) fabricating aesthetic components of said robot based on said digital three-dimensional model;
(e) fabricating mechanical components of said robot based on said mechanical design; and
(f) assembling said aesthetic and mechanical components into a completed robot.

2. The method of claim 1, wherein said digital three-dimensional model creating step (b) includes: utilizing a computer and digital modeling software to create said digital three-dimensional model of said character design.

3. The method of claim 1, wherein said digital three-dimensional model creating step (b) comprises:
(i) creating a physical sculpture of said character design; and
(ii) importing a three-dimensional digital representation of said physical sculpture into a digital modeling software application.

4. The method of claim 3, wherein said importing substep (b) (ii) includes at least one of: performing a three-dimensional scan of said physical sculpture; and creating a three-dimensional photo model of said physical sculpture.

5. The method of claim 1, wherein said digital three-dimensional model step (b) and said mechanical design creating step (c) are performed iteratively until said mechanical components fit comfortably and properly operate in the digital three-dimensional model of said aesthetic components.

6. The method of claim 1, wherein said component fabricating step (d) includes:
(i) saving said digital three-dimensional model in a file format readable by a physical rapid-prototyping machine;
(ii) loading said saved file onto said physical rapid-prototyping machine; and
(iii) creating physical pieces of said digital three-dimensional model with said physical rapid-prototyping machine.

7. The method of claim 6, wherein said component fabricating step (d) further includes:
(iv) creating molds from said physical pieces; and
(v) casting said components from said molds.

8. The method of claim 6, wherein said component fabricating step (d) further includes:
reinforcing said physical pieces from substep (iii) with a liquid hardener.

9. The method of claim 6, wherein said component fabricating step (d) further includes:
refining imperfections in said physical pieces.

10. The method of claim 7, wherein said component casting substep (v) includes:
(1) casting one or more rigid components for the robot from their corresponding molds; and
(2) casting one or more flexible components for the robot from their corresponding molds.

11. The method of claim 10, wherein said rigid component casting method substep (1) includes:
(A) pouring catalyzed liquid in a plurality of rigid component mold pieces;
(B) reassembling and fastening together said rigid component mold pieces;
(C) rotating said fastened rigid component mold until said catalyzed liquid has sufficiently hardened; and
(D) opening said mold and removing said rigid component therefrom.

12. The method of claim 10, wherein said rigid component casting method substep
(1) further includes: building up multiple layers of reinforcement material and catalyzed liquid in said mold pieces prior to said catalyzed liquid pouring substep (A).

13. The method of claim 10, wherein said flexible component casting method substep (2) includes:
(A) pouring catalyzed liquid in a plurality of flexible component mold pieces;
(B) reassembling and fastening together said flexible component mold pieces;
(C) rotating said fastened flexible component mold until said catalyzed liquid has sufficiently firmed; and
(D) opening said mold and removing said flexible component therefrom.

14. A method for designing and fabricating a robot in a virtual space to pre-test how internal and external components for the robot fit and properly work together before any such components are acquired or fabricated, said method comprising the steps of:
(a) creating a digital three-dimensional model of said robot; and
(b) creating a mechanical design for said robot based on said digital three-dimensional model.

15. The method of claim 14, wherein said digital three-dimensional model creating step (a) includes: utilizing a computer and digital modeling software to create said digital three-dimensional model of said robot.

16. The method of claim 14, wherein said digital three-dimensional model creating step (a) comprises:
(i) creating a physical sculpture of said robot; and
(ii) importing a three-dimensional digital representation of said physical sculpture into a digital modeling software application.

17. The method of claim 16, wherein said importing substep (a) (ii) includes at least one of: performing a three-dimensional scan of said physical sculpture; and creating a three-dimensional photo model of said physical sculpture.

18. The method of claim 14, wherein said digital three-dimensional model step (a) and said mechanical design creating step (b) are performed iteratively until said internal components for the robot comfortably fit and properly operate in said external components for the robot.

19. A method for designing and fabricating a new, three-dimensional robot with one or more moving components to test how internal and external components for the robot will fit and work together before any components for the robot are fabricated, said method comprising the steps of:
(a) utilizing a computer and digital modeling software to create a digital three-dimensional model of said robot;
(b) creating a mechanical design for the moving components of said robot based on said digital three-dimensional model; and
(c) testing how internal and external components for the robot fit and work together on said digital three-dimensional model.

20. The method of claim 19, wherein said digital three-dimensional model creating step (a) comprises:
(i) creating a physical sculpture of said robot; and
(ii) importing a three-dimensional digital representation of said physical sculpture into said digital modeling software either by: (1) performing a three-dimensional scan of said physical sculpture; or (2) creating a three-dimensional photo model of said physical sculpture.
